(19) United States
(12) Patent Application Publication
(10) Pub. No.: US 2011/0244360 A1
(43) Pub. Date: Oct. 6, 2011

(54) ELECTROLYTIC MEMBRANE STRUCTURE FOR FUEL CELL AND FUEL CELL

(75) Inventors: Ryoichi Shimoi, Yokohama-shi (JP); Atsushi Ohma, Yokohama-shi (JP); Yoshitaka Ono, Yokosuka-shi (JP)

(73) Assignee: NISSAN MOTOR CO., LTD.

(21) Appl. No.: 13/160,227

(22) Filed: Jun. 14, 2011

Related U.S. Application Data
(62) Division of application No. 10/579,038, filed on Jun. 13, 2008.

(30) Foreign Application Priority Data
Nov. 12, 2003 (JP) 2003-382655

(51) Int. Cl. H01M 8/10

(52) U.S. Cl. 429/481

(57) ABSTRACT

A catalyst layer 2 is formed by conductive particles 4 carrying catalyst particles 5, and a boundary layer 3 is disposed adjacent to the catalyst layer 2 and is positioned between a portion which is easily contacted with an oxygen gas and the catalyst layer 2. The boundary layer 3 is formed by the conductive particles 4 carrying the catalyst particles 5 and a catalyst-carrying amount in the boundary layer 3 is smaller than a catalyst-carrying amount in the catalyst layer 2 and a hydrophilic treatment is carried out on the conductive particles 4 of the boundary layer 3 by a hydrophilic material, such that the hydrophilic characteristics of the conductive particles of the boundary layer are higher than that of the catalyst layer.

### CROSS-REFERENCE TO RELATED APPLICATIONS

This application is a divisional of and claims priority to U.S. application Ser. No. 10/579,038, filed Jun. 13, 2008, which is a National Stage entry of PCT/JP2004/016380, filed Oct. 28, 2004, the disclosures of which are hereby incorporated by reference in their entirety.

### TECHNICAL FIELD

The present invention relates to an electrolytic membrane structure for a fuel cell and a fuel cell.

### BACKGROUND OF THE INVENTION

A fuel cell with a proton-exchange membrane electrolytic membrane includes on each of both membrane faces a catalyst layer for promoting an electrochemical reaction. The catalyst layer is formed by flocculating and laminating carbon particles or the like which carry a catalyst such as platinum or the like.

In such fuel cell, an electrochemical reaction of H2→2H⁺+2e⁻ is carried out through the catalyst in an electrode in an anode side to which a hydrogen gas is supplied, and an electrochemical reaction of O2+4H⁺+4e⁻→2H2O is carried out through a catalyst in an electrode in a cathode side to which an oxygen is supplied, to generate an electromotive force at each electrode.

In the above-described fuel cell, the oxygen is mixed with the hydrogen gas supplied to the electrode in the anode side due to some causes, for example, a seal defect or a seal deterioration between the electrode and the electrolytic membrane, and as a result, when the oxygen remains in a peripheral area of the catalyst layer, the oxygen and the hydrogen perform a combustion reaction to produce a temperature increase in a local part of the electrolytic membrane in the vicinity of the periphery of the catalyst layer, which causes heat deterioration of the electrolytic membrane.

In order to avoid such problems, Japanese Patent Publication No. 7-201346 A has proposed that a carbonized layer lined around the catalyst layer with carbon particles which do not carry catalysts is formed in a band shape. According to the Patent Publication, the carbonized layer produces almost no electrochemical reaction, so that a temperature increase in the electrolytic membrane can be restricted.

### SUMMARY OF THE INVENTION

In such fuel cell with the carbonized layer having no catalyst, the combustion reaction of the oxygen and the hydrogen is restricted, as well as the electrochemical reaction is not almost generated whereby a temperature in the vicinity of the carbonized layer gets lowered. However, unreacted hydrogen gases increase in the vicinity of the carbonized layer and then the unreacted gases generate the electrochemical reaction in the vicinity of a boundary to the catalyst layer adjacent to the carbonized layer, which causes a temperature increase in a local part of the electrolytic membrane.

Since the carbonized layer does not include catalysts, when the hydrogen gas passing through the carbonized layer in the form of hydrogen molecules reaches the electrolytic membrane and further, passes into the cathode side through the electrolytic membrane, still being in a state of the hydrogen molecules, the hydrogen and the oxygen produce a combustion reaction in the catalyst layer in the cathode side, possibly heat-deteriorating the electrolytic membrane due to the generated heat.

The present invention has an object of improving a thermal durability of an electrolytic membrane structure for a fuel cell.

The present invention comprises an electrolytic membrane structure, the electrolytic membrane structure provides with an electrolytic membrane placed between an electrode in an anode side and an electrode in a cathode side, a catalyst layer formed by closing up conductive particles carrying catalysts on each face, in the anode side and in the cathode side, of the electrolytic membrane, the each face contacts to each of the electrodes, and a boundary layer which is adjacent to the catalyst layer in the anode side on one face of the electrolytic membrane and is formed between a portion to be easily contacted with an oxygen gas and the catalyst layer, wherein the boundary layer is formed by closing up the conductive particles carrying the catalysts, as well as a catalyst-carrying amount in the boundary layer is smaller than a catalyst-carrying amount in the catalyst layer.

And the present invention, in place of the above boundary layer, is provided with a boundary layer formed by closing up conductive particles to which a hydrophilic treatment is carried out.

### BRIEF EXPLANATION OF THE DRAWINGS

FIG. 1 is a schematic cross sectional view showing a cell of a fuel cell to which the present invention can be applied.

FIG. 2 is a plan view showing an electrolytic membrane structure for a fuel cell of a first embodiment according to the present invention.

FIG. 3 is a cross sectional view showing the same in FIG. 2.

FIG. 4 is a characteristic view showing a distribution in a membrane face temperature of the electrolytic membrane structure for the fuel cell.

FIG. 5 is a plan view showing an electrolytic membrane structure for a fuel cell of a second embodiment according to the present invention.

FIG. 6 is a plan view showing a separator for a fuel cell of a third embodiment according to the present invention.

FIG. 7 is a plan view showing an electrolytic membrane structure for the fuel cell of the third embodiment according to the present invention.

FIG. 8 is a plan view showing another example of an electrolytic membrane structure for a fuel cell of the third embodiment according to the present invention.

FIG. 9 is a plan view showing a separator for a fuel cell of a fourth embodiment according to the present invention.

FIG. 10 is a plan view showing an electrolytic membrane structure for a fuel cell of the fourth embodiment according to the present invention.

FIG. 11 is a cross sectional view showing an electrolytic membrane structure for a fuel cell of a fifth embodiment according to the present invention.

FIG. 12 is a cross sectional view showing an electrolytic membrane structure for a fuel cell of a sixth embodiment according to the present invention.

FIG. 13 is a cross sectional view showing an electrolytic membrane structure for a fuel cell of a seventh embodiment according to the present invention.

FIG. 14 is a cross sectional view showing an electrolytic membrane structure for a fuel cell of an eighth embodiment according to the present invention.

FIG. 15 is a characteristic view showing a distribution in a membrane face temperature of the electrolytic membrane structure for the fuel cell in the eighth embodiment or the like.

FIG. 16 is a cross sectional view showing an electrolytic membrane structure for a fuel cell of a ninth embodiment according to the present invention.

FIG. 17 is a cross sectional view showing an electrolytic membrane structure for a fuel cell of a tenth embodiment according to the present invention.

### BEST MODES TO CARRY OUT THE PRESENT INVENTION

A first embodiment of the present invention will be explained.

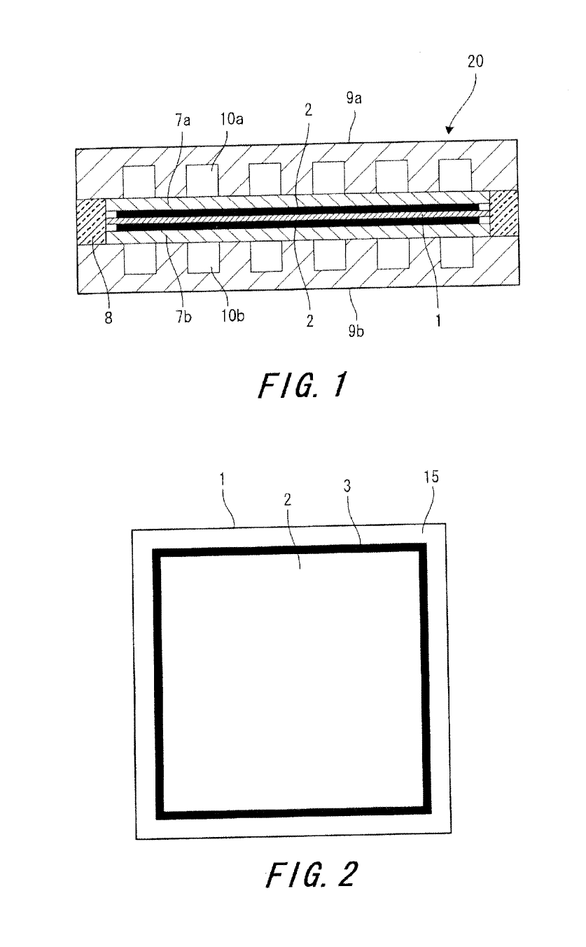

FIG. 1 shows a first embodiment of a fuel cell to which the present invention can be applied.

Each unit cell 20 of the fuel cell comprises an electrolytic membrane 1 having an ion permeability, an electrode 7a in an anode side and an electrode 7b in a cathode side which are placed opposite with each other, sandwiching the electrolytic membrane 1, a catalyst layer 2 interposed respectively between the electrolytic membrane 1 and the electrode 7a and between the electrolytic membrane 1 and the electrode 7b, and separators 9a and 9b located respectively outside of each electrode 7a and 7b to include gas flow passages 10a and 10b for supplying a fuel gas and an oxidant gas.

It is noted that a seal member 8 is placed between the separators 9a and 9b to seal a periphery of the electrolytic membrane 1. The seal member 8 may be installed so as to sandwich both sides of the electrolytic membrane 1.

And the fuel cell is formed by sequentially laminating a plurality of the cell 20.

A fuel gas, for example, a hydrogen gas is supplied into the gas passage 10a in the anode side and an oxidant gas, for example, an air is supplied into the gas passage 10b in the cathode side.

Each electrode 7a and 7b, and the seal member 8 are sandwiched by the separators 9a and 9b. The electrodes 7a and 7b have a gas diffusion characteristic and therefore, the hydrogen gas and the air supplied from the gas flow passages 10a and 10b can reach the catalyst layer 2 passing through an inside of the electrodes 7a and 7b.

The catalyst layer 2 is coated on each face of the anode side and the cathode side of the electrolytic membrane 1. The catalyst layer 2, however, is not limited to it, but may be coated on electrode faces of the electrodes 7a and 7b opposite to the electrolytic membrane 1.

FIG. 2 shows an electrolytic membrane structure. The catalyst layer 2 is disposed in each central area on both membrane faces of the electrolytic membrane 1 and a boundary layer 3 is formed in a band shape around the catalyst layer 2.

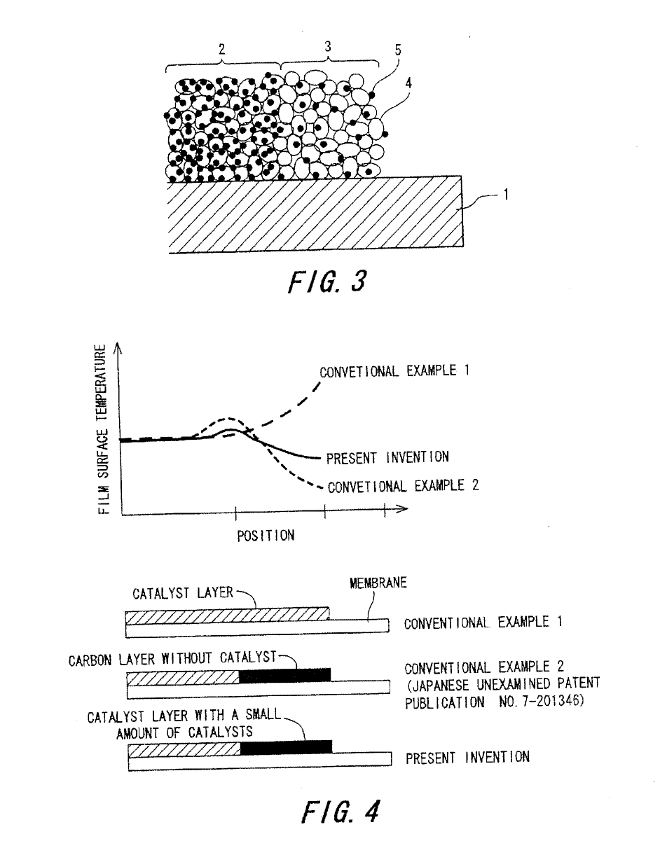

FIG. 3 shows an enlarged cross section of the electrolytic membrane structure where the catalyst layer 2 is formed by coating so that many conductive particles 4 carrying catalyst particles 5 are closely paved on both the membrane faces of the electrolytic membrane 1.

On the contrary, the boundary layer 3 is formed by coating so that many conductive particles 4 carrying catalyst particles 5 are closely paved on both the membrane faces of the electrolytic membrane 1, and a catalyst-carrying amount in the boundary layer 3 is set less than a catalyst-carrying amount in the catalyst layer 2.

A ratio of an amount of the catalyst particles 5 carried on the surface of the conductive particles 4 in the boundary layer 3 to an amount of the catalyst particles 5 carried on the surface of the conductive particles 4 in the catalyst layer 2 is set as an appropriate value based upon an experiment result or the like, and as an example, approximately ⅓- 1/10.

In any one of the catalyst layer 2 and the boundary layer 3, the conductive particles 4 are formed by carbon particles and the catalyst particles 5 are formed by, for example, platinic particles.

In the boundary layer 3 and the catalyst layer 2, particle diameters of the conductive particles 4 are set to be substantially the same and an air gap rate between the conductive particles 4 is set to be substantially equal. The conductive particles 4 forming the boundary layer 3 and the catalyst layer 2 have a water repellent characteristic.

The boundary layer 3 is formed adjacent to the periphery of the catalyst layer 2 without clearance thereof. The conductive particles 4 of the catalyst layer 2 and the conductive particles 4 of the boundary layer 3 are contacted with each other on a plane perpendicular to the membrane face of the electrolytic membrane 1.

The conductive particles 4 of the catalyst layer 2 and the conductive particles 4 of the boundary layer 3, however, are not limited to the above, may be contacted with each other on a plane oblique to the membrane face of the electrolytic membrane 1. Or the conductive particles 4 of the catalyst layer 2 and the conductive particles 4 of the boundary layer 3 may be overlapped on the membrane face of the electrolytic membrane 1. A catalyst-carrying amount of the conductive particles 4 in the boundary layer 3 may have the density of the catalysts which can vary in the direction of the membrane face of the electrolytic membrane 1.

And different from the construction that as shown in FIG. 2, both the catalyst layer 2 and the boundary layer 3 are coated on both the membrane faces of the electrolytic membrane 1, the boundary layer 3 only may be formed on the anode side-membrane face, namely the boundary layer 3 may be not formed on the cathode side-membrane face.

And the catalyst layer 2 may be coated on the electrolytic membrane 1 and the boundary layer 3 positioned around the catalyst layer 2 may be coated on the electrodes 7a and 7b. And on the contrary, the catalyst layer 2 may be coated on the electrodes 7a and 7b, and the boundary layer 3 may be coated on the electrolytic membrane 1.

As described above, the catalyst layer 2 is formed in the central area of the electrolytic membrane 1. The boundary layer 3 extends in a band-like shape over an entire periphery of a region surrounding the catalyst layer 2 of the electrolytic membrane 1.

An extra region on which conductive particles carrying the catalysts are not coated extends in a band-shape over an entire periphery of the boundary layer 3 of the electrolytic membrane 1. However, the boundary layer 3 is not limited to the above, but may be coated to the outermost periphery of the electrolytic membrane 1 without disposing the extra region 15.

Each unit cell 20 of the fuel cell generates power by electrochemical reaction.

In detail, a fuel gas supplied through a gas passage 10a in the anode side passes through the electrode 7a with gas diffusion property and is led to the catalyst layer 2 in the anode side. In the catalyst layer 2 in the anode side hydrogen in the fuel gas is converted into proton (H2→2H⁺+2e⁻). The proton diffuses though the electrolytic membrane 1 in a hydrated state and moves to the catalyst layer 2 in the cathode side.

The oxidant gas supplied through the gas passage 10b in the cathode side passes through the electrode 7b with gas diffusion property and is led to the catalyst layer 2 in the cathode side. In the catalyst layer 2 in the cathode side the proton having passed through the electrolytic membrane 1 is combined with the oxygen in the oxidant gas to generate water (O2+4H⁺+4e⁻→2H2O). Thus, in each catalyst layer 2, the electrochemical reaction is advanced causing heat generation to generate an electromotive force between each electrode.

When an air is leaked into in the vicinity of the catalyst layer 2 in the anode side due to a seal defect or seal deterioration of a seal member 8 held between the separators 9a and 9b during the heat generating of the fuel cell, the hydrogen and the oxygen are burned and reacted to cause a temperature increase in the periphery of the catalyst layer 2 locally, thereby to deteriorate the electrolytic membrane 1.

However, according to the present invention, the boundary layer 3 which is placed at a position easily contacting the oxygen around the catalyst layer 2 is formed of conductive particles carrying a small amount of the catalysts. Therefore, even if the oxygen passes though the vicinity of the electrode 7a and reaches the boundary layer 3, the oxygen is difficult to burn and react with the hydrogen rapidly, thereby to restrict a temperature increase due to the combustion reaction.

And the hydrogen which has reached the boundary layer 3 generates the electrochemical reaction, but since a catalyst amount in the boundary layer 3 is smaller than in the catalyst layer 2, the electrochemical reaction in the boundary layer 3 is mild and the reaction heat to be generated therein is smaller than in the catalyst layer 2. And this slow electrochemical reaction allows reduction of unreacted hydrogen gases in the vicinity of the catalyst layer 2 including the boundary layer 3, thereby to avoid concentration of the unreacted gases in the vicinity of the periphery of the catalyst layer 3. Accordingly the electrochemical reaction is not excessively provided to avoid the temperature increase in a local part of the electrolytic membrane 1.

Since the electrochemical reaction of the hydrogen gases occurs slowly, a small amount of the hydrogen gases reaches the electrolytic membrane 1 in a state of hydrogen components, and further, the event that the hydrogen gases pass through the electrolytic membrane 1 in a state of the hydrogen components and reach the catalyst layer in the cathode side and then, occurrence of the combustion reaction of the hydrogen and oxygen in the cathode side is generated is prevented.

By thus equalizing the temperature distribution of the electrolytic membrane 1, heat deterioration of the electrolytic membrane 1 is restricted to improve durability of the fuel cell.

And the reaction efficiency of the boundary layer 3 is lower as compared to the catalyst layer 2, but since the electrochemical reaction is generated even in the boundary layer 3, the power generation efficiency of the fuel cell is improved than in case the boundary layer 3 is formed of the carbonized layer in which any electrochemical reaction does not occur as conventional.

FIG. 4 is a temperature characteristic view showing a temperature state of a membrane face of the electrolytic membrane 1 as compared to the related art. An ordinate in FIG. 4 shows a temperature of the electrolytic membrane 1 and an abscissas shows a position from an end of the electrolytic membrane 1.

The conventional example 1 shows a structure of disposing only a catalyst layer on an electrolytic membrane and the conventional example 2 shows an electrolytic membrane structure of Japanese Patent Publication No. 7-201346A showing a case of a carbonized layer formed of paving carbon particles on the periphery of the catalyst layer without carrying the catalysts.

In the case of the conventional example 1, it is seen that in the periphery of the electrolytic membrane tends to contact the oxygen, a temperature increases due to the combustion reaction of the hydrogen and the oxygen. And in the case of the conventional example 2, due to no disposition of a catalyst layer in the carbonized layer the combustion reaction and the electrochemical reaction are not generated. Therefore, no heat is generated to lower the temperature. However, since many hydrogen gases passing through the electrode with the gases still remain unreacted in the vicinity of the carbonized layer, the combustion reaction and the electrochemical reaction become active in the vicinity of the boundary of the carbonized layer, causing a temperature increase locally.

In contrast, according to the present invention in the boundary layer 3 in the periphery of the catalyst layer 2 the combustion reaction and the electrochemical reaction are performed gradually and the temperature becomes lower as compared to that of the conventional example 1 and the unreacted gases are reduced. As a result, the reaction of the catalyst layer 2 in the vicinity of the boundary to the carbonized layer is not as active as in the conventional example 2, to avoid a temperature increase in a local part of the electrolytic membrane 1 properly.

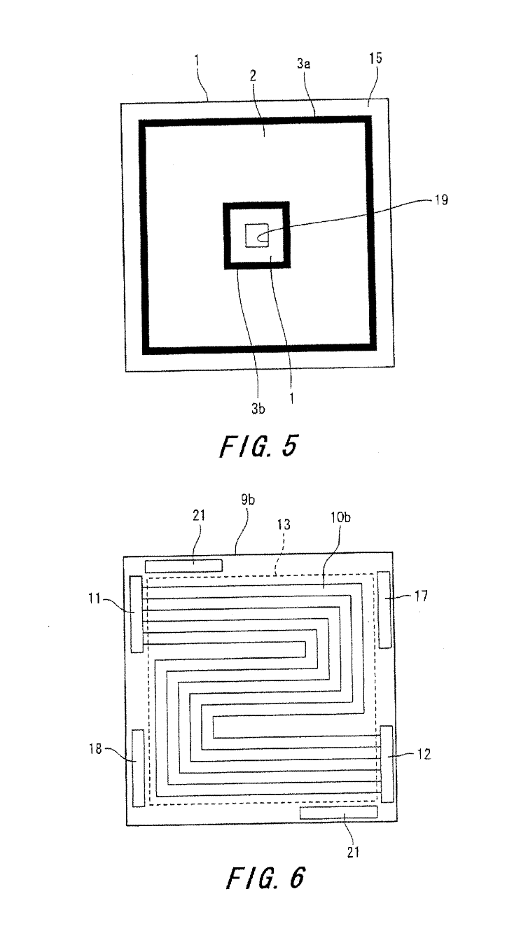

FIG. 5 shows an electrolytic membrane structure for a fuel cell of a second embodiment according to the present invention.

A penetrating bore 19 is formed in a central portion of the electrolytic membrane 1 in the lamination direction of the cell 20 to flow an oxidant gas. A gas flow passage 10b of a separator 9b in the cathode side is connected to the penetrating bore 19.

A catalyst layer 2 is formed so as to surround the penetrating bore 19. In this type of the electrolytic membrane 1, not only the periphery of the catalyst layer 2 but also the circumferential portion of the penetrating bore 19 becomes positions which tend to contact the oxygen. Accordingly the boundary layer 3a, 3b are formed both in an outer portion of the catalyst layer 2 and in an inner portion of the catalyst layer 2 surrounding the penetrating bore 19.

This restricts combustion reaction of the unreacted gases in an outer and an inner end of the catalyst layer 2 and equalizes a temperature distribution of the electrolytic membrane 1 to restrict heat deterioration.

FIGS. 6-8 show a third embodiment of the present invention.

FIG. 6 shows a separator 9b in a cathode side on a surface of which a gas passage 10b is formed extending in a meandering shape to introduce an oxidant gas 8 for example, air. The gas passage 10b is formed of a plurality of grooves placed in parallel with each other.

In a corner of the separator 9b, an inlet gas manifold 11 into which the oxidant gas is supplied and an outlet gas manifold 12 from which the oxidant gas is discharged are formed to penetrate therethrough. One end of the gas flow passage 10b is connected to the inlet gas manifold 11 and the other end thereof is connected to the outlet gas manifold 12, which causes the oxidant gas flowing from the inlet gas manifold 11 into the gas passage 10b to flow in a meandering shape along the gas passage 10b and be discharged from the outlet manifold 12 in the other end.

And a region on a surface of the separator 9b shown by a dotted line is a heat generation area 13 and shows a size of the catalyst layer 2 disposed in the electrolytic membrane 1. Accordingly the inlet gas manifold 11 and the outlet gas manifold 12 are disposed outside of the heat generation area 13.

As seen with reference to FIG. 1, the inlet gas manifold 11 and the outlet gas manifold 12 penetrate through the separator 9b in the lamination direction of the cell 20, and a manifold (penetrating passage) is disposed in the corresponding position of the separator 9a in the anode side and the oxidant gas is supplied and discharged through each cell 20.

And in order to supply a fuel gas (for example, hydrogen gas) to the gas passage 10a of the separator 9a in the anode side and to be discharged therefrom, an inlet gas manifold 17 and an outlet gas manifold 18 are disposed to penetrate through the separator 9a, and also in a position corresponding to each manifold in the separator 9b of the cathode side.

One set of openings 21, 21 disposed in a corner of the separator 9b form a part of a passage for introducing a cooling water to cool the cell 20.

It is noted that the gas flow passage 10b is called a serpentine flow passage or a meandering flow passage formed of a plurality of flow passages being extended in parallel and in a meandering shape, but may be, not limited to the above, a comb-shaped joint flow passage or an interdigitated flow passage.

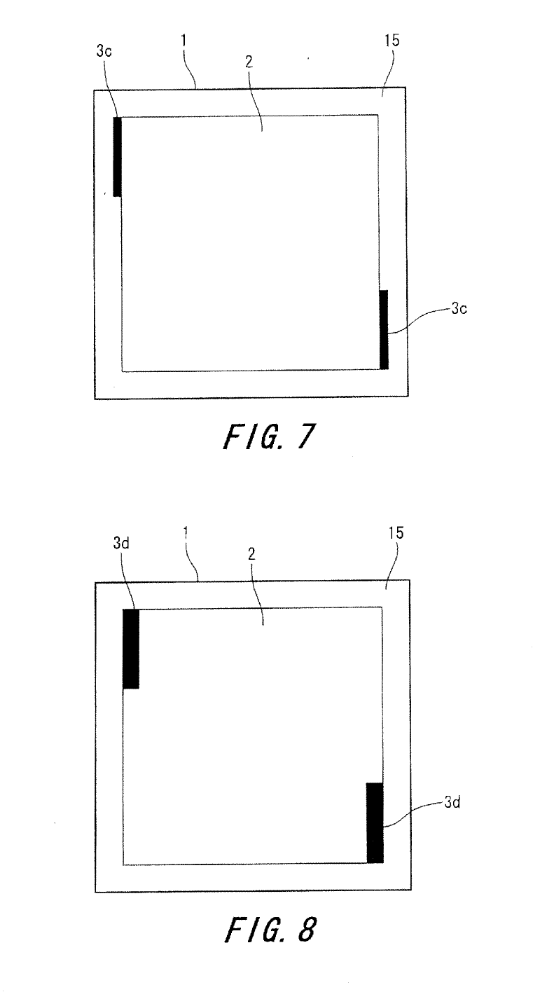

FIG. 7 shows one face in the anode side of the electrolytic membrane 1 disposed corresponding to such separator 9b.

Two elongated, rectangular boundary layers 3c,3c are formed in both sides of the catalyst layer 2 on the membrane face of the electrolytic membrane 1 to be limited to positions close to the inlet gas manifold 11 and the outlet gas manifold 12. each boundary layer 3c extends in a band shape along the inlet gas manifold 11 and the outlet gas manifold 12, each having substantially the same length.

Or as shown in FIG. 8, the elongated, rectangular boundary layer 3d,3d may be formed so as to be entered inside catalyst layer 2 in a position close to each of the inlet gas manifold 11 and the outlet gas manifold 12.

Since the oxidant gas, for example, an air flows in the inlet gas manifold 11 and the outlet gas manifold 12, this periphery becomes a portion which tends to contact the oxygen. Therefore, the boundary layers 3c,3d are formed inside the inlet gas manifold 11 and the outlet gas manifold 12, adjacent to at least the catalyst layer 2 of the anode side. Since a catalyst-carrying amount of the conductive particles 4 in the area of the boundary layer 3c(3d) is smaller than in the catalyst layer 2, the combustion reaction of the hydrogen and the oxygen is restricted in the same as described above, as well as the electrochemical reaction is restricted, thereby to control a temperature increase due to heat generation.

Forming the boundary layers 3c,3d to be limited at the positions close to the inlet gas manifold 11 and the outlet gas manifold 12 allows a smaller size of the boundary layers 3c,3d, thereby to reduce a coating amount of the boundary layers 3c,3d formed by coating. And an elimination amount of an area of the catalyst layer 2 by the boundary layers 3c,3d is small and reduction of the electromotive force of the cell 20 is prevented by the corresponding amount.

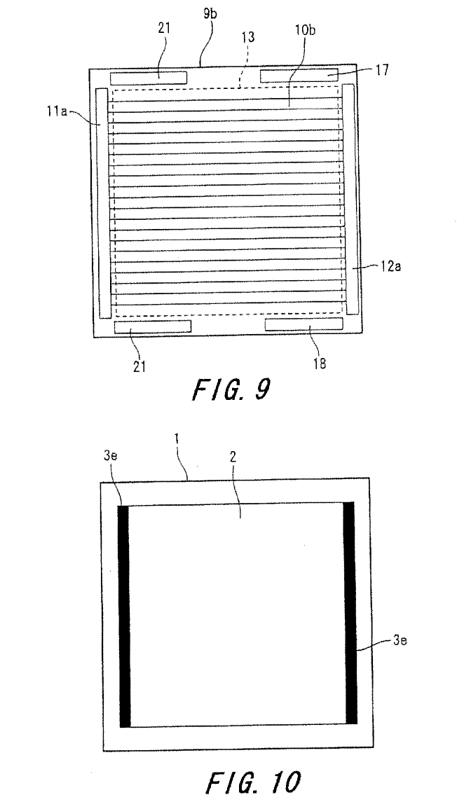

FIGS. 9 and 10 show a fourth embodiment of the present invention.

FIG. 9 shows a separator 9b in a cathode side where a gas flow passage 10b formed in the separator 9b includes a plurality of grooves linearly extending in parallel with each other. Both ends of the gas flow passage 10b are connected respectively to the inlet gas manifold 11a and the outlet gas manifold 12a. The inlet gas manifold 11a and the outlet gas manifold 12a extend in an elongated shape in both sides of the heat generation area 13.

FIG. 10 shows an electrolytic membrane structure including an electrolytic membrane 1 where in both sides of the catalyst layer 2 formed on the membrane face in at least the anode side of the electrolytic membrane 1, elongated and rectangular boundary layers 3e,3e are formed along an inside of portions close to the inlet gas manifold 11a and the outlet gas manifold 12a.

In this case, since the boundary layers 3e,3e are formed to be limited to positions close to the inlet gas manifold 11a and the outlet gas manifold 12a, the combustion reaction thereof is restricted to prevent a temperature increase of the boundary layers 3e,3e. And due to limiting an area of the boundary layer 3e to be small, a coating amount of the conductive particles 4 by coating can be reduced. And as a result, this restricts elimination of the area of the catalyst layer 2 by the boundary layers 3e,3e, to prevent reduction of an electromotive force of the cell 20.

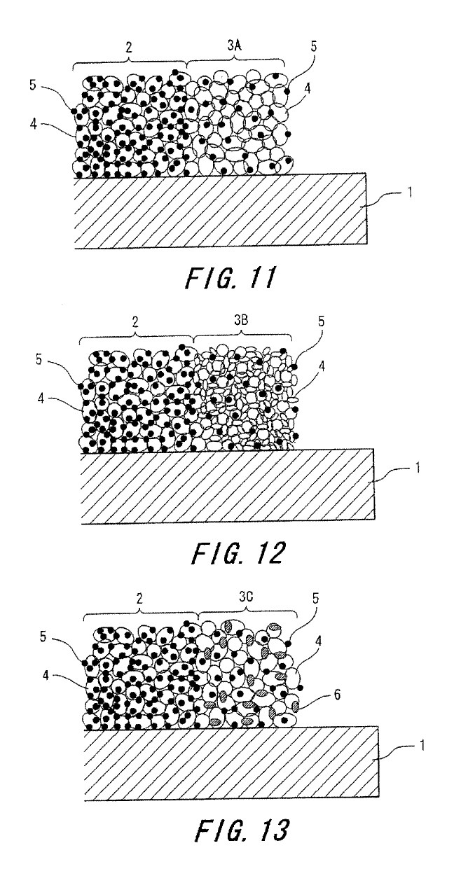

FIG. 11 shows a fifth embodiment of the present invention.

FIG. 11 shows a cross sectional view of an electrolytic membrane structure where an air gap rate between conductive particles 4 in a boundary layer 3A is set as smaller than an air gap between conductive particles 4 in a catalyst layer 2. Namely a density of the conductive particles 4 in the boundary layer 3A is higher than in the catalyst layer 2.

a ratio of the air gap rate between the conductive particles in the boundary layer 3A to the air gap rate (for example, 30%) between the conductive particles in the catalyst layer 2 is set as any value, for example, ½-⅕ based upon an experiment result or the like.

However, a particle diameter of the conductive particles 4 is set to be substantially the same in the boundary layer 3A and the catalyst layer 2.

It is noted that, as described above, a catalyst-carrying amount of the conductive particles 4 in the boundary layer 3A is set as smaller than in the catalyst layer 2.

The conductive particles 4 are closely placed more densely in the boundary layer 3A than in the catalyst layer 2 to restrict the passing of the unreacted hydrogen gas through the boundary layer 3A and reduce the hydrogen gas reaching the electrolytic membrane 1. This prevents occurrence of the event that the hydrogen gas passes through the electrolytic membrane 1 and the hydrogen gas and the oxygen gas burn in the catalyst layer 2 of the cathode side, to produce a temperature increase in a local part of the electrolytic membrane 1.

And high density of the boundary layer 3A allows an increase of the heat conductivity in the boundary layer 3A, to enable uniformity of a temperature distribution in the electrolytic membrane 1.

FIG. 12 shows a cross sectional view of an electrolytic membrane structure of the sixth embodiment according to the present invention.

A particle diameter of conductive particles 4 in a boundary layer 3B is set as smaller than a particle diameter of conductive particles 4 in a catalyst layer 2. And an air gap rate between the conductive particles 4 in a boundary layer 3B is set as smaller than an air gap between the conductive particles 4 in a catalyst layer 2.

A ratio of the air gap rate between the conductive particles 4 in the boundary layer 3B to the air gap rate between the conductive particles in the catalyst layer 2 is set as any value, for example, ½-⅕ based upon an experiment result or the like.

Reducing the particle diameter of the conductive particles 4 in the boundary layer 3B simply enables higher density of the boundary layer 3B as compared to that in the catalyst layer 2.

In this case, also in the same as in the fifth embodiment a temperature increase in a local part of the electrolytic membrane 1 can be prevented more efficiently.

FIG. 13 shows a cross sectional view of an electrolytic membrane structure of a seventh embodiment according to the present invention.

Conductive particles 4 of a boundary layer 3C, in the same as shown in each of the above-described embodiments, carry a smaller number of catalysts than in the catalyst layer 2. Further, a hydrophilic treatment, not a water repellent treatment, is carried out to the conductive particles 4 in the boundary layer 3C with a hydrophilic material 6.

It is noted that a particle diameter of the conductive particles 4 in the boundary layer 3C is substantially the same as that in the catalyst layer 2. An air gap of the conductive particles 4 in the boundary layer 3C is substantially the same as that in the catalyst layer 2.

One of several methods exists as a method of carrying out the hydrophilic treatment to the conductive particles 4 made of carbon particles, for example, as follows.

An electrolytic oxidation treatment or an oxidation treatment of an acidic solution is carried out to the carbon particles to give functional group as a hydrophilic material on a surface of the carbon particle. A surface active agent as the hydrophilic material 6 is provided on the surface of the carbon particle. An oxidant as the hydrophilic material 6 such as SiO2 or TiO2, or a liquid or powder material used as an electrolytic membrane are attached on the surface of the carbon particle. Or the surface of the carbon particle is roughened by carrying out a plasma treatment thereon.

When the hydrophilic treatment is thus carried out to the conductive particles 4 in the boundary layer 3C, the water which is generated in the cathode side by the electrochemical reaction and is a part of the water which passes through the electrolytic membrane 1 to the anode side can be held inside the boundary layer 3C. As a result, heat conductivity of the boundary layer 3C containing the water is increased and even if in the border vicinity of the catalyst layer 2 adjacent to the boundary layer 3C the unreacted gases cause more electrochemical reactions, heat generated in the border vicinity tends to escape to the boundary layer 3C having a low temperature. Accordingly diffusion of the temperature which tends to increase in the border vicinity is rapidly performed to equalize the temperature distribution of the electrolytic membrane 1 and improve durability of the electrolytic membrane 1.

And existence of the water in the boundary layer 3C restricts the passing of the unreacted hydrogen gases through the boundary layer 3C. This prevents combustion reaction of the oxygen and the hydrogen occurring when the hydrogen components move to the cathode side of the electrolytic membrane 1 through the boundary layer 3C, to avoid heat deterioration of the electrolytic membrane 1.

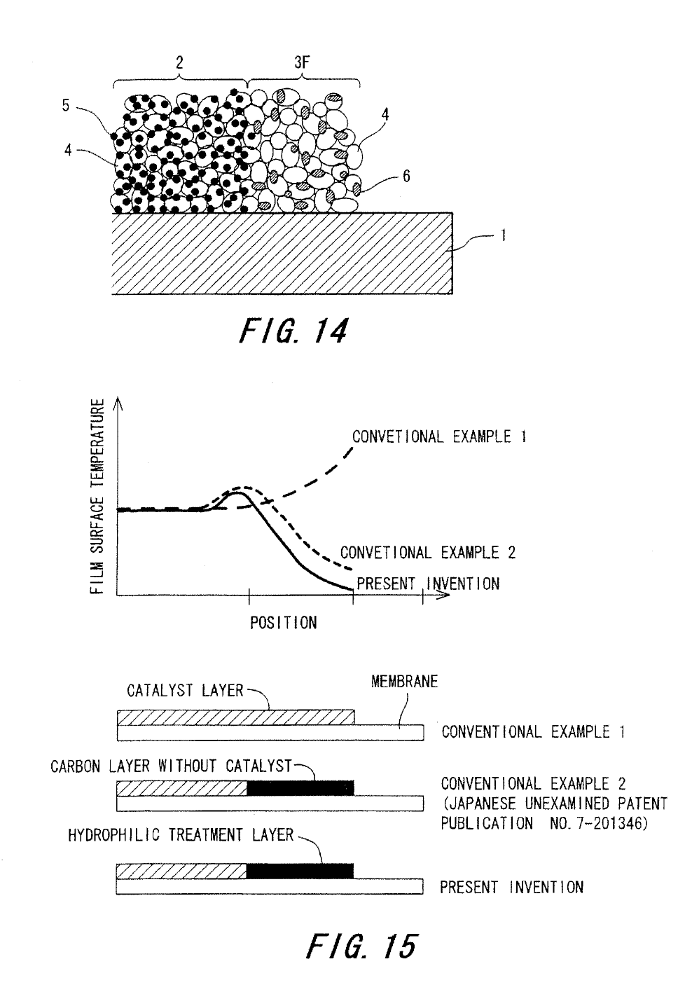

FIG. 14 shows a cross sectional view of an electrolytic membrane structure for a fuel cell of an eighth embodiment according to the present invention.

In the present embodiment, a boundary layer 3F located between a portion which tends to contact oxygen and the catalyst layer 2 is formed by conductive particles 4 not carrying catalysts, different from each embodiment described above. A hydrophilic treatment is carried out to the conductive particles 4 in the boundary layer 3F with a hydrophilic material. It is noted that a method of the hydrophilic treatment is performed in the same way as in the embodiment in FIG. 13.

A particle diameter and an air gap of the conductive particles 4 in the boundary layer 3F are set to be substantially the same as that in the catalyst layer 2.

Since in the embodiment the conductive particles 4 in the boundary layer 3F do not carry catalysts, the electrochemical reaction and the combustion reaction do not occur in the boundary layer 3F and the temperature in the boundary layer 3F is lower than in the catalyst layer 2. However, the unreacted hydrogen gases tend to remain in the boundary vicinity between the boundary layer 3F and the catalyst layer 2. Accordingly many electrochemical reactions of the unreacted hydrogen gases and many combustion reactions with the oxygen are performed in the catalyst layer 2 close to the border to boundary layer 3F, possibly to increase a temperature.

However, the hydrophilic treatment is carried out to the boundary layer 3F to reserve water inside the boundary layer 3F, whereby heat conductivity of the boundary layer 3F is increased and heat of the catalyst layer 2 generated in the border vicinity of the boundary layer 3F is quickly transmitted to the boundary layer 3F having a lower temperature to avoid a temperature increase in the local part of the electrolytic membrane 1 close to the border to the catalyst layer 2.

The water reserved in the boundary layer 3F prevents the unreacted gases having passed through the electrode 7a from traveling to the electrolytic membrane 1 in a hydrogen component state. Therefore, the hydrogen gas passing through the electrolytic membrane 1 from the anode side to the cathode side does not generate the combustion reaction in the catalyst layer in the cathode side to block a temperature increase of the electrolytic membrane 1.

Thus in the embodiment, the conductive particles 4 in the boundary layer 3F do not carry catalysts, but the hydrophilic treatment is carried out thereto, and the temperature is low and the heat conductivity is high. Therefore, the temperature distribution in the electrolytic membrane 1 is uniform and the heat deterioration of the electrolytic membrane 1 is avoided to improve durability as a fuel cell.

FIG. 15 is a temperature characteristic view showing a temperature state of a membrane face of the electrolytic membrane 1 as compared to the related art. An ordinate in FIG. 15 is a temperature of the electrolytic membrane 1 and an abscissa in FIG. 15 is a position from an end of the electrolytic membrane 1.

The conventional examples 1 and 2 shown are the same as in FIG. 4.

In the case of the conventional example 1, it is understood that a temperature in the periphery of the catalyst which tends to contact oxygen increases due to combustion reaction of the hydrogen and the oxygen. In the case of the conventional example 2, the combustion reaction and the electrochemical reaction do not occur due to no catalyst carried in the carbon layer and the heat is not generated to lower the temperature. However, since many unreacted hydrogen gases having passed through the electrode remain in the vicinity of the carbon layer, the combustion reaction and the electrochemical reaction become active in the catalyst layer close to the border to the carbonized layer to cause a temperature increase locally.

On the contrary, according to the present invention, as described above, heat conductivity in the boundary layer 3F is high and the heat generated in the vicinity of the border to the catalyst layer 2 is positively escaped to the lower temperature side, which restricts a local temperature increase of the electrolytic membrane 1.

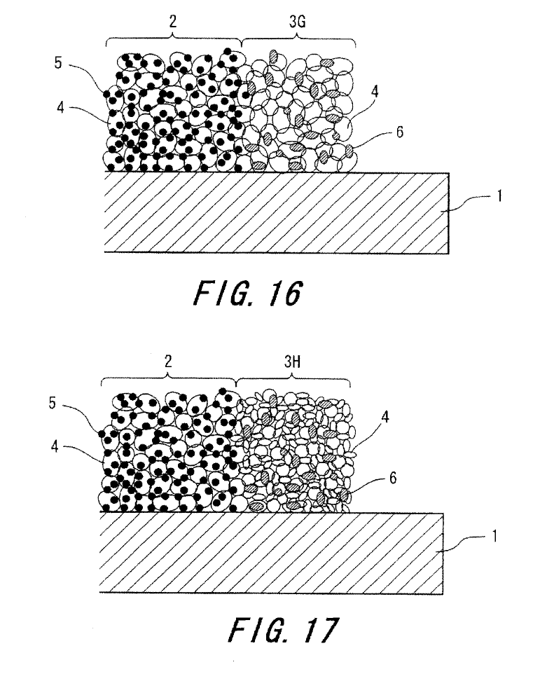

FIG. 16 shows a ninth embodiment of the present invention. In the embodiment, in the same way as in the embodiment shown in FIG. 14, a boundary layer 3G does not carry catalysts, as well as is formed of conductive particles 4 to which a hydrophilic treatment is carried out with a hydrophilic material 6.

And in the embodiment an air gap rate between conductive particles 4 in a boundary layer 3G is set as smaller than an air gap between conductive particles 4 in a catalyst layer 2.

A ratio of each of the air gap rates between the conductive particles in the boundary layer 3G and the catalyst layer 2 is set as any value, such as ½-⅕ which is decided based upon an experiment result or the like.

However, a particle diameter of the conductive particles 4 is set to be substantially the same in the boundary layer 3G and the catalyst layer 2.

The conductive particles 4 are closely placed more densely in the boundary layer 3G than in the catalyst layer 2, which restricts the passing of the unreacted hydrogen gases through the boundary layer 3G, as well as increases the heat conductivity in the boundary layer 3G to enable uniformity of a temperature distribution in the electrolytic membrane 1.

FIG. 17 shows a cross sectional view of an electrolytic membrane structure for a fuel cell of a tenth embodiment of the present invention.

In the embodiment, in the same way as in the embodiment shown in FIG. 14, a boundary layer 3H does not carry catalysts, as well as is formed of conductive particles 4 to which a hydrophilic treatment is carried out with a hydrophilic material 6.

And a particle diameter of the conductive particles 4 in the boundary layer 3H is smaller than that in the catalyst layer 2, which causes an air gap rate of the conductive particles 4 in the boundary layer 3H to be smaller than that in the catalyst layer 2.

A smaller size of the particle diameter of the conductive particles 4 in the boundary layer 3H easily allows a higher density of the boundary layer 3H. Such high density of the boundary layer 3H increases heat conductivity of the boundary layer 3H to which the hydrophilic treatment is carried out.

The embodiments 8-10 can be applied to the electrolytic membrane 1 shown in each of FIGS. 2 and 5, and further to the electrolytic membrane structure shown in each of FIGS. 7, 8 and 10.

In any one of these cases, the boundary layer 3 is formed adjacent to the catalyst layer 2, as well as positioned between the catalyst layer 2 and a portion which tends to contact oxygen.

It is apparent that the present invention is not limited to the above embodiments and various changes and modifications can be made within the scope of the technical concept of the present invention.

### INDUSTRIAL APPLICABLE

The present invention can be applied to a fuel cell which generates power with a fuel gas and an oxidant gas.

1. An electrolytic membrane structure for a fuel cell, comprising:
an electrolytic membrane placed between an electrode in an anode side and an electrode in a cathode side;
a catalyst layer formed by closing up conductive particles carrying catalysts on each face, in the anode side and in the cathode side, of the electrolytic membrane, the each face contacts to each of the electrodes; and
a catalyst layer in the anode side and in the cathode side formed on each face of the electrolytic membrane, wherein the each face is opposite each of the electrodes and the catalyst layer is formed by closing up conductive particles carrying catalysts; and
a boundary layer which is adjacent to the catalyst layer in the anode side on one face of the electrolytic membrane, as well as is formed between a portion to be easily contacted with an oxygen gas and the catalyst layer in the anode side, wherein the boundary layer is formed by closing up the conductive particles carrying the catalysts, as well as a catalyst-carrying amount in the boundary layer is smaller than a catalyst-carrying amount in the catalyst layer, wherein a hydrophilic treatment is carried out to the conductive particles in the boundary layer.

2. The electrolytic membrane structure for the fuel cell as defined in claim 1, wherein
the boundary layer is formed so as to surround a periphery of the catalyst layer, which is easily contacted with the oxygen gas.

3. The electrolytic membrane structure for the fuel cell as defined in claim 1, wherein
the boundary layer is formed between a portion which is easily contacted with the oxygen gas and which is in the vicinity of a penetrating passage by which the oxygen gas is supplied to the cathode side, and the catalyst layer.

4. The electrolytic membrane structure for the fuel cell as defined in claim 1, wherein
an air gap rate between the conductive particles in the boundary layer is smaller than an air gap rate between the conductive particles in the catalyst layer.

5. The electrolytic membrane structure for the fuel cell as defined in claim 1, wherein
a particle diameter of the conductive particles in the boundary layer is smaller than a particle diameter of the conductive particles in the catalyst layer.

6. The electrolytic membrane structure for the fuel cell as defined in claim 1, wherein
a hydrophilic treatment is carried out to the conductive particles in the boundary layer.

7. A fuel cell with an electrolytic membrane placed between an electrode in an anode side and an electrode in a cathode side, comprising:
a catalyst layer in the anode side and in the cathode side formed on either a face of the electrolytic membrane or a face of the electrode, which is a contacting face between the electrolytic membrane and the each electrode and formed by closing up conductive particles carrying catalysts; and
a boundary layer which is adjacent to the catalyst layer in the anode side on one face of the electrolytic membrane or the electrode and is formed between a portion to be easily contacted with an oxygen gas and the catalyst layer in the anode side, wherein the boundary layer is formed by closing up the conductive particles carrying the catalysts, as well as a catalyst-carrying amount in the boundary layer is smaller than a catalyst-carrying amount in the catalyst layer, wherein a hydrophilic treatment is carried out to the conductive particles in the boundary layer.

8. An electrolytic membrane structure for a fuel cell, comprising:
an electrolytic membrane placed between an electrode in an anode side and an electrode in a cathode side;
a catalyst layer formed by closing up conductive particles carrying catalysts on each face, in the anode side and in the cathode side, of the electrolytic membrane, the each face contacts to each of the electrodes; and
a boundary layer which is adjacent to the catalyst layer in the anode side on one face of the electrolytic membrane and is formed between a portion to be easily contacted with an oxygen gas and the catalyst layer in the anode side, wherein the boundary layer is formed by closing up the conductive particles to which a hydrophilic treatment is carried out.

9. The electrolytic membrane structure for the fuel cell as defined in claim 8, wherein
the boundary layer is formed so as to surround a periphery of the catalyst layer, which is easily contacted with the oxygen gas.

10. The electrolytic membrane structure for the fuel cell as defined in claim 8, wherein
the boundary layer is formed between a portion which is easily contacted with the oxygen gas and which is in the vicinity of a penetrating passage by which the oxygen gas is supplied to the cathode side, and the catalyst layer.

11. The electrolytic membrane structure for the fuel cell as defined in claim 8, wherein
an air gap rate between the conductive particles in the boundary layer is smaller than an air gap rate between the conductive particles in the catalyst layer.

12. The electrolytic membrane structure for the fuel cell as defined in claim 8, wherein
a particle diameter of the conductive particles in the boundary layer is smaller than a particle diameter of the conductive particles in the catalyst layer.

13. A fuel cell with an electrolytic membrane placed between an electrode in an anode side and an electrode in a cathode side, comprising:
a catalyst layer in the anode side and in the cathode side formed on either a face of the electrolytic membrane or a face of the electrode, which is a contacting face between the electrolytic membrane and the each electrode, wherein the catalyst layer is formed by closing up conductive particles carrying catalysts; and
a boundary layer which is adjacent to the catalyst layer in the anode side on one face of the electrolytic membrane or the electrode, as well as is formed between a portion to be easily contacted with an oxygen gas and the catalyst layer in the anode side, wherein the boundary layer is formed by closing up the conductive particles to which a hydrophilic treatment is carried out.
